(19) United States
(12) Patent Application Publication
(10) Pub. No.: US 2005/0051418 A1
(43) Pub. Date: Mar. 10, 2005

(54) Distiller for liquids, liquids distillation method and equipment for treating sewage, which equipment includes said distiller

(76) Inventor: Ramiro Perez Lama, Granollers (ES)

Correspondence Address: STEINBERG & RASKIN, P.C., 1140 AVENUE OF THE AMERICAS, 15th FLOOR, NEW YORK, NY, 10036-5803, US

(21) Appl. No.: 10/480,501

(22) PCT Filed: May 30, 2002
(86) PCT No.: PCT/IB02/01943

(30) Foreign Application Priority Data
Jun. 11, 2001 (ES) P 200101339

(51) Int. Cl. B01D 1/00; B01D 1/28

(52) U.S. Cl. 203/21; 159/16.3; 159/24.1; 159/26.1; 159/43.1; 202/175; 202/176; 202/182; 202/200; 203/24; 203/26; 203/DIG. 8; 203/95; 203/96

(57) ABSTRACT

The distiller includes an exchanger (6) of tubes (7) which fill with the liquid to be treated, means (14) of heating, means (23) for compressing the steam from evaporation of the liquid, means (24) for feeding the compressed steam around the tubes (7) and means (27, 28) for inducing turbulence into the liquid, preferably by making the compressed steam bubble inside it. The method includes heating the liquid and supplying it to the tubes of the exchanger, compressing the resulting steam and bringing it into contact with the exterior of the tubes. The equipment uses a distiller such as that described. The invention permits treatment of sewage and other liquids by distillation, with minimum energy consumption and in a small space.

This invention relates to a distiller for liquids, which includes a heat exchanger with a housing which contains a plurality of tubes, into which is fed the liquid to be treated, means of supplying the liquid to the tubes, means of heating the liquid, means for compressing the steam from evaporation of the liquid, means for feeding the compressed steam into the housing around the tubes and means for removing on the one hand the condensate and on the other the concentrated residue.

The invention also relates to a method for distilling liquids in which this distiller is used, and to equipment for purifying the sewage included in said distiller.

### BACKGROUND OF THE INVENTION

On people-transport equipment which has toilet facilities, such as railways, the sewage generated has to be disposed of.

One possibility is to store the waste in a tank, from which it is removed at intervals for treatment thereof in conventional fixed installations; this system nevertheless requires periodic maintenance and substantial storage space if the tank is not emptied very often.

Some recent systems are based on treatment of the sewage on board the transport equipment itself, though a number of major problems are raised in implementing such solutions.

On the one hand, the sewage has a very high level of contamination, since practically all of it is from toilets which are evacuated by means of vacuum systems with very low consumption of water at each flush (of the order of 0.7 litres per flush); as a result, the conventional treatment systems used at treatment plants and other similar facilities are not useful for this application.

Furthermore, transport equipment has major limitations both in terms of physical space for housing the facilities and supplies of power for consumption.

Finally, it must be borne in mind that solids or liquids with certain levels of contamination cannot simply be disposed of into the environment.

Some systems developed for treatment of the sewage on the means of transport itself consist in biological treatments combined with physical treatments.

Biological treatments have several disadvantages: on the one hand, the bacteria require maintenance, have a limited life and are delicate when subjected to quite simple aggressions, such as bleach, colognes and other similar products which can be poured into the toilet bowl on a railway train; and on the other hand, the solids obtained from the biological treatment and the subsequent physical treatment must be stored for later treatment at an outside plant, for due to their high levels of contamination they cannot simply be expelled onto the track. There is therefore still a need for emptying of tanks and treatment at fixed facilities.

Another disadvantage of this type of systems is that the disinfection treatment following the biological treatment, which is carried out by heating the liquid, involves high energy consumption.

Another method might consist in evaporation by direct heating of the liquid to be distilled, though this again has the disadvantage of high energy consumption.

There also exist facilities for the desalination of water and treatment of industrial waste waters, all such facilities being large and with high energy consumption, using a distillation system in which the latent heat contained in the evaporated steam is recuperated and used to produce boiling in a heat exchanger system, by means of mechanical compression of the steam In these systems, the water to be treated is recirculated using pumps and is sprayed onto the walls of the tubes of an exchanger, while the previously compressed steam is directed onto the outside of the tubes; by giving up heat to the water through the walls of the tubes, the steam condenses. Spraying of the water is necessary in order to achieve a good thermal exchange coefficient.

Although in some respects this treatment system could be suitable for sewage on transport equipment, the necessarily small dimensions of the overall installation make good operation thereof impossible. For example, the recirculation pumps would suffer phenomena of cavitation due to the low head of water available at the suction indraught point, and the spraying nozzles would become blocked continuously due to their small size and the high quantities of solids in suspension.

### DESCRIPTION OF THE INVENTION

The objective of this invention is to resolve the disadvantages mentioned by developing a distiller for liquids and equipment for treating the sewage which, from the point of view of energy expenditure and space occupation, satisfactorily resolves the problems of elimination of sewage on moving equipment, such as railway rolling stock.

In accordance with a first aspect of this invention a distiller is proposed for liquids, characterised in that the liquid-feed means keep the tubes full of liquid up to a predetermined level, and in that said distiller further includes means for inducing turbulence in the liquid which is in the tubes.

These characteristics permit the problem of treatment of sewage with high contaminant content to be resolved by a process of distillation based on mechanical compression of the steam, while at the same time resolving the problems of energy consumption and large size.

It is important to note that in this description the term “tubes” is used to refer to the ducts containing the liquid to be treated, and must not be interpreted in the literal sense of a duct of round, square or similar section, for the exchanger could also be of the plate type, in which a number of parallel plates form ducts or spaces of long section, inside which the liquid to be treated and the injected steam alternate with each other so that they are kept separate by the plates. In this case, the “tubes” are the spaces between two adjacent plates which contain the liquid to be treated, while the “exterior of the tubes” is formed by the spaces between two adjacent plates into which the steam is injected.

Preferably, the means for setting up turbulence in the liquid include a duct for injecting some of the steam coming from the compressor into the liquid.

The compressed steam causes the liquid to bubble and sets up ascending currents of water in the tubes of the exchanger, thus achieving strong turbulence and good heat exchange.

Also preferably, said duct for injecting some of the steam into the liquid runs in the bottom part of the distiller and consists in a tube with a plurality of lateral steam outlet orifices.

In one embodiment, the distiller also includes a substantially horizontal plate situated inside the housing, above the tubes, with a diameter less than that of the housing.

This plate favours the turbulence by returning to the tubes the liquid which emerges from them owing to the oiling and turbulence.

Advantageously, the distiller also includes a filter of perforated plates, situated above the tubes; in one embodiment, said filter is made up of a horizontal plate with a perforated central zone and at least one perforated annular plate, fixed onto the bottom part of said horizontal plate, around its perforated central zone.

The filter can prevent the bubbles and foam from the liquid reaching the steam outlet.

Preferably, the housing has a lower tank, connected to the tubes and surrounded by means of heating the liquid; said lower tank can have a duct with a valve for extracting the concentrated residues.

This tank permits good decantation of the solids in the bottom part of the distiller.

In one embodiment, said means for compressing the steam consist in a side-channel blower.

Optionally, the distiller includes a condensate outlet calibrated to a predetermined diameter so as to avoid losses of output.

In a suitable constructional embodiment, the housing of the distiller is made of up an intermediate section with the tubes of the heat exchanger, an upper section with a steam outlet and a lower section with an inlet for the liquid to be treated and with a concentrated residue outlet, these three sections being attached to each other by means of detachable fixing means.

This construction method facilitates manufacturing, assembly and disassembly of the distiller.

In accordance with a second aspect of this invention, a liquids distillation method is proposed which includes the following operations: heating the liquid to be treated and delivering it inside the tubes of a heat exchanger; compressing the steam resulting from evaporation of the liquid and bringing it into contact with the exterior wall of the exchanger tubes; and removing the condensate and the concentrated residue, and is characterised in that the tubes of the exchanger are kept full of liquid up to a predetermined level, and turbulence is induced in the liquid in the tubes.

The method has excellent energy efficiency, and is suitable for liquids with high levels of contamination.

In accordance with a preferred embodiment, said turbulence in the liquid is induced by injecting some of the compressed steam into the liquid to make it bubble.

Preferably, the method includes a stage of preheating the liquid to be treated, with recuperation of the heat of the condensate obtained from the steam; this stage improves the energy efficiency of the process.

In accordance with a third aspect, this invention also relates to equipment for treating sewage which includes a distiller of the above-mentioned characteristics.

Thanks to the advantages of the distiller described, equipment of this type is of low consumption and low volume and weight, which makes it particularly suitable for fitting on vehicles, mainly passenger-transport vehicles (such as trains, coaches, etc.) for treating water from toilets, kitchens, showers and other facilities in the vehicles. It is also suitable in transportable modules utilisable as toilets, camping kitchens and others, in which the water has to be treated in order to dispose of it into the environment or reuse it, in situations of scarcity of water and difficulty in obtaining sufficient electrical energy, or even in fixed locations, especially where there are difficulties in water or energy supply.

Preferably, the equipment further includes a heat recuperator for preheating the water to be treated, in which the condensate extracted from the distiller gives up heat to the water to be treated, before the water is supplied to the distiller, in order to improve the energy efficiency of the unit as a whole.

In one embodiment, the equipment includes a residues storage tank divided into two parts by a filtering divider, with one of the parts of the tank connected to an inlet duct for the sewage to be treated and an inlet duct for the concentrate residue from the distiller, while the other part of the tank is connected to a water for sucking up the water to be treated.

Thanks to the treatment of the invention, the tank can be emptied at much longer intervals than in conventional facilities.

In accordance with a preferred embodiment of the equipment of the invention, that latter also includes means for drying the concentrated residues.

Drying of the residues is very advisable, since it greatly reduces the volume of the final residues which have to be stored or expelled, while it further allows the residues to be expelled into the environment because it converts them into non-polluting powder.

Advantageously, said means of drying include a compartment with means of heating and provided with an inlet for the concentrated residues, an outlet for the dry residues, a gases and smoke outlet and a duct for feeding in air.

In one embodiment the equipment also includes means of mechanical separation of the solids contained in suspension in the sewage before they are fed to the distiller.

Optionally, said means of mechanical separation of the solids include a screw conveyor whose housing has a perforated lower part for the outlet of liquid through it.

In one embodiment, the equipment includes a catalyst for elimination of ammonia, situated at the outlet from the steam compression means or in a smoke outlet duct.

### BRIEF DESCRIPTION OF THE DRAWINGS

For a better understanding of all that has been set out, some drawings are attached which show schematically and solely by way of non-restrictive example a practical case of embodiment.

In said drawings:

FIG. 1 is a schematic diagram showing an embodiment of the distiller of the invention, installed in equipment for treating sewage;

FIG. 2 is a cross-section of the distiller of FIG. 1;

FIG. 3 is a schematic diagram of equipment for treating sewage, with a heat recuperator for preheating of the liquid to be treated;

FIG. 4 is schematic diagram of equipment similar to that of FIG. 3, with a storage tank; and

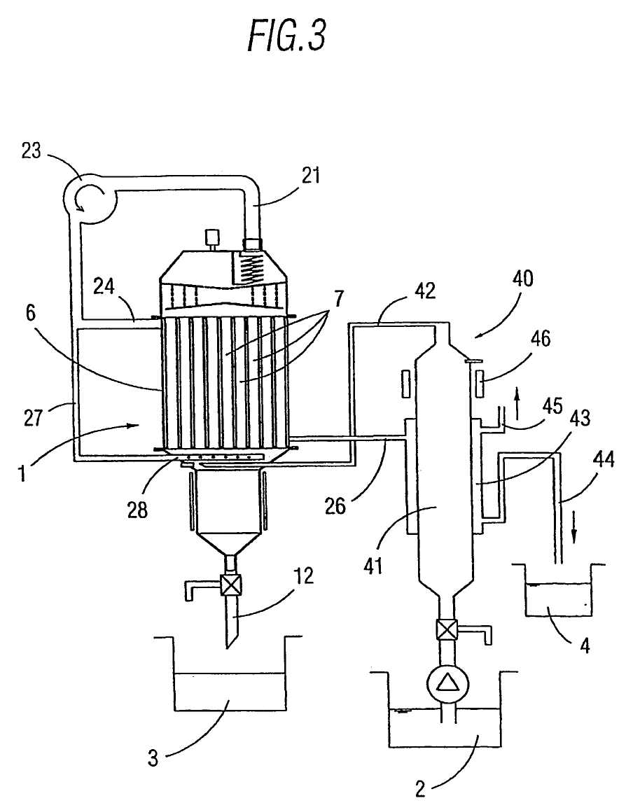

FIG. 3 is a schematic diagram of equipment for treating sewage provided with an initial separator of solids and liquids and a device for drying the residue.

### DESCRIPTION OF PREFERRED EMBODIMENTS

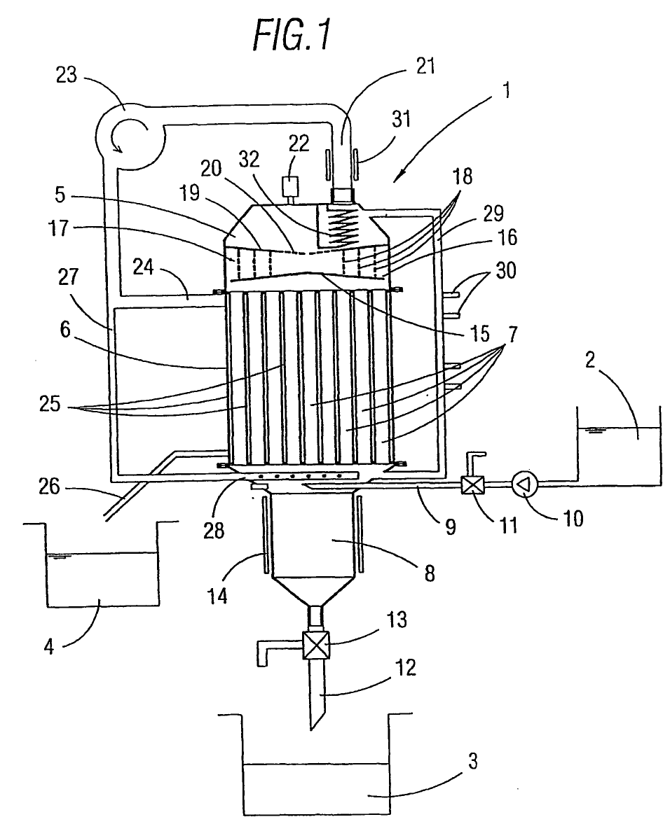

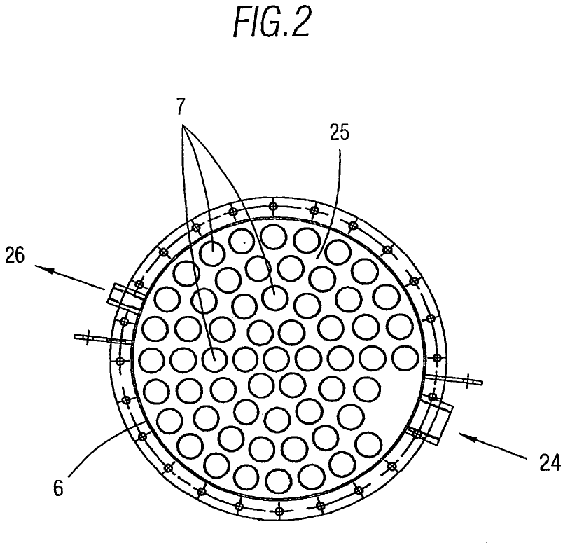

FIGS. 1 and 2 show a first embodiment of a piece of equipment for the treatment of sewage, the main element of which equipment is a distiller 1 in accordance with the invention.

The equipment includes a tank 2 for sewage to be treated, for example the sewage tank of the toilet of a railway carriage; a tank 3 of concentrated residues, and a tank 4 of clean water as the product of distillation.

Throughout the description which follows reference is made to treatment equipment applied to railways, although it is clear that the same equipment, with or without modifications, is applicable to many other different uses.

The distiller 1 is made up of a housing formed by three sections: a cover or upper section 5, an exchanger 6 provided with vertical tubes 7 open at both ends, and a cover or lower section 8.

The tubes 7 could also be inclined, if for example the distiller must be placed in a location of low height.

The lower section 8 includes inlet tubing 9 for water from the tank 2 to be treated, with a corresponding supply pump 10 and a valve 11, and forms a space for decantation of the solid or concentrated residue, which is emptied through a residue outlet 12 provided with a valve 13. The tapered shape of the lower section 8 facilitates the concentration of residues for emptying thereof.

The tube 9 could be mounted vertically, traversing the heat exchanger and coming out at the same zone; in this case, there would be an effect of preheating of the water to be treated.

An annular heating element 14 is mounted around a cylindrical part of the lower section 8.

The pump 10 supplies the water to be treated from the tank 2 to the distiller, filling the tubes 7 of the exchanger and maintaining a certain level of water in them; in the lower section 8 the water is heated up to around 100° C., such that the entire mass of water in the lower part 8 and in the tubes 7 is boiling. As the water in the tubes 7 evaporates the solid falls down through the tubes and is collected in the lower section 8, whose concentration of solid increases until it is emptied.

The heating of the water up to temperatures close to 100° C., in addition to causing the water to evaporate, promotes flocculation and has the advantage of disinfecting the water by eliminating the bacteria, so that the water is treated and disinfected in a single process.

In the upper section 5 of the distiller 1 is fitted a slightly conical plate 15, of smaller diameter than that of the housing and situated above the tubes 7. Grooves 16 are formed between the plate 15 and the wall of the housing for passage of the steam from evaporation of the water in the tubes 7. The boiling water contained in the tubes 7 strikes against the plate 15 and is returned to the tubes, and only the steam can rise towards the upper part of the distiller.

Above the plate 15 there is a perforated-sheet filter 17 formed by three concentric perforated annular plates 18 and a horizontal plate 19 perforated at its central part 20. This filter can serve to break the foam and the bubbles which form by boiling of the dirty water, preventing them reaching the upper part of the distiller. An alternative solution would be to make the distiller taller; the filter means that the apparatus can be of a smaller size.

At the upper part of the distiller 1 is a steam outlet 21 and a safety valve 22.

The steam outlet 21 feeds the steam to a mechanical compressor 23, which can for example be a side-channel blower, known in other applications. The compressor 23 can have a drainage tube (not shown) towards the distiller 1, so as to remove any condensate which forms in it.

The steam from the compressor 23 is fed through a duct 24 to the heat exchanger 6, in the space 25 outside the tubes 7. Thanks to compression, the enthalpy of the steam increases and it tends to condense, so that in the exchanger 6 the steam gives up heat to the water and condenses. The latent heat of the steam is thus used to induce evaporation of the water, while the condensate, made up of clean water, is collected in the tank 4 through a condensate outlet duct 26. This duct 26 is preferably calibrated to a predetermined diameter in order to prevent outlet of steam and attendant loss of efficiency.

Under normal circumstances exchange of heat between the steam and the water would be small, due to the scant temperature gradient, but in this invention, as explained below, the thermal exchange is improved to the point of achieving a system with low energy consumption.

Some of the steam from the compressor 23 is recirculated toward the water to be treated, via a duct 27, and is made to bubble in the lower section 8 of the distiller through a perforated diffuser tube 28. The introduction of pressurised steam into the water to be treated through the orifices in the tube 28 sets up turbulence in the water, in the form of a violent bubbling, both in the lower section 8 of the distiller and in the tubes 8; this turbulence spectacularly increases the coefficient of heat exchange between the water and the steam, and as a result notable increases the energy efficiency of the distiller.

FIG. 1 also shows a level device 29 with level sensors 30, associated with the distiller 1 in order to monitor its operation.

Provision has also been made for the fitting of a heating element 31 around the tube 21 in order to provide better drying of the steam fed to the compressor 23; instead of an exterior element, however, an element 32 could be fitted for the same purpose inside the housing. Both elements have been shown in FIG. 1.

There follows a description of the distillation method in accordance with the invention, according to a basic embodiment, which will be understood easily following the description of the distiller.

The liquid to be treated is heated and fed to the interior of the tubes 7, maintaining a certain level inside them; the steam from boiling of the liquid is compressed, and the compressed steam is supplied partly to the heat exchanger so that it gives up heat to the liquid and condenses and partly directly to the liquid in order to set up turbulence therein.

On the one hand the condensate is obtained, which is clean water, and on the other hand the concentrated residue deposited by decantation is removed. The distilled water obtained can be reutilised or disposed of into the environment; as will be seen below, the residue can be stored and withdrawn at certain intervals, or it can be dried or burned and expelled into the environment.

The approximate energy-consumption figures involved in a conventional process and in the process described are, by way of example, the following: in a conventional process, 80 kcal/kg would be needed to heat the water from 20° C. to 100° C., and a further 538 kcal/kg to evaporate the water at 1 bar pressure, making a total of 618 kcal/kg. In the process described, by means of steam compression, the same 80 kcal/kg are required to heat the water, but only 20 kcal/kg to evaporate it, making a total of some 100 kcal/kg. As can be seen, the invention permits energy consumption to be reduced to one-sixth.

On the basis of the basic embodiment of the equipment and the method described additional elements can be added which improve or complement the distiller; there follows a description of equipment fitted with additional elements, although this description is not exhaustive and other elements could be added, or those described combined, depending on the specific requirements of each case.

In all the drawings, for the purposes of greater clarity, any single part has always been marked with the same reference number.

FIG. 3 shows sewage treatment equipment which, in addition to the distiller 1, has a heat recuperator 40.

The water to be treated is fed from the tank 2 to the lower part of an inner cylindrical chamber 41 of the heat recuperator 40; it ascends through that chamber and emerges through the upper part, from which a tube 42 takes it to the inlet 9 of the distiller 1.

Around the chamber 41 the heat recuperator 40 has an annular chamber 43 which receives through its upper part the distilled water from the condensate outlet 26 from the distiller. The distilled water emerges through the lower part of the annular chamber and is taken to the clean water tank 4 through a tube 44 which forms a trap; the air and other gases emerge to the exterior through a duct 45 (marked with an arrow).

The residual heat of the clean water obtained in the distiller is thus used to preheat the water to be treated, thereby improving the energy efficiency of the equipment.

An annular heating element 46 can be fitted in the upper part of the heat recuperator 40 in order to heat the water up to a temperature suitable for the distiller 1. That element 46 can replace the element 14 in the distiller or can constitute an additional heating element.

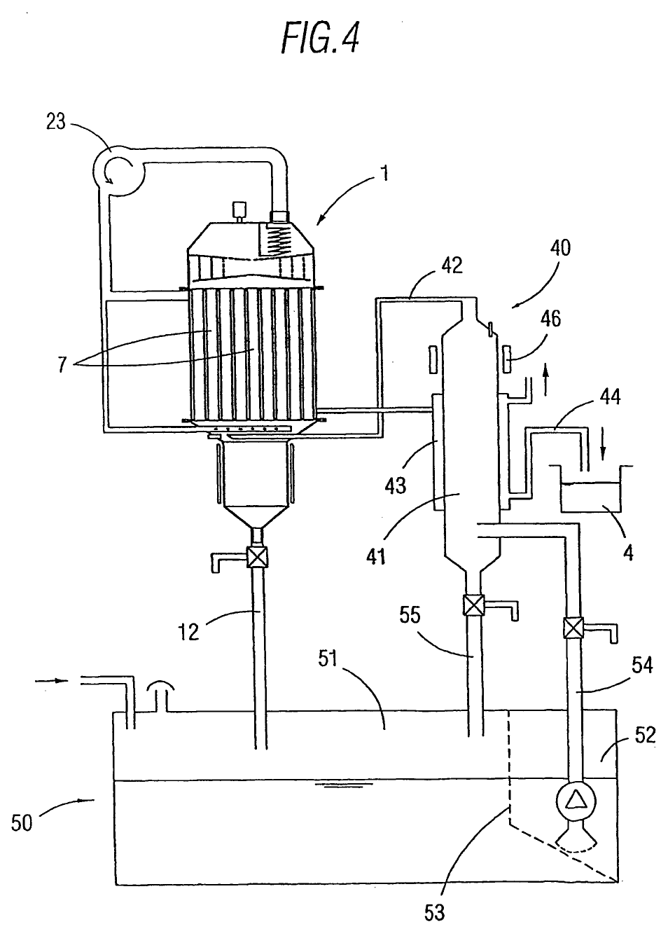

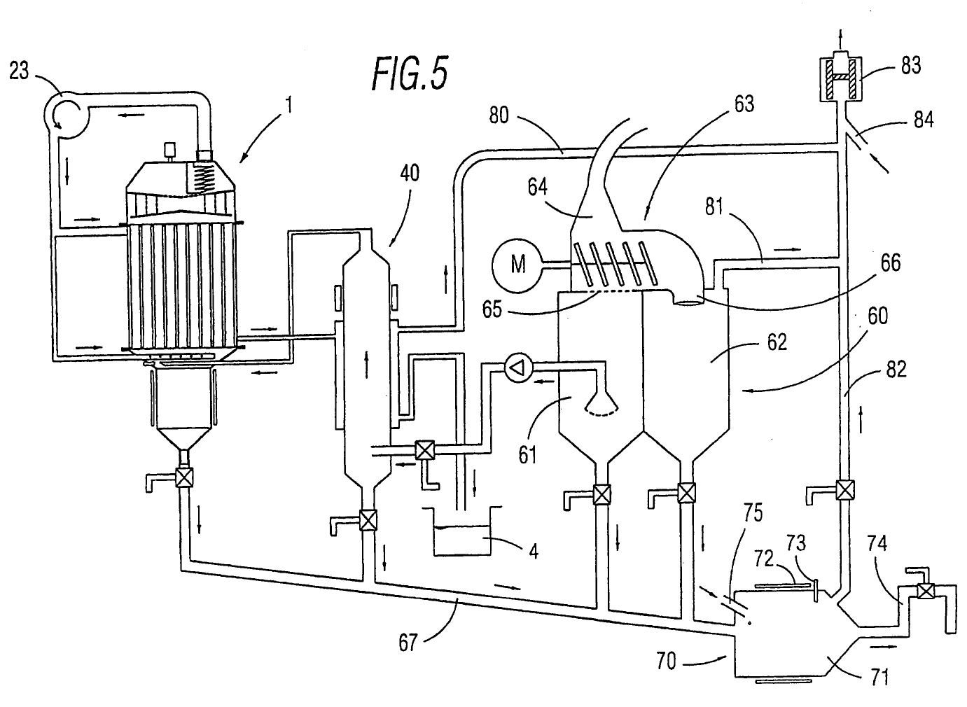

FIG. 4 shows a modified embodiment of the equipment shown in FIG. 3; in this case the equipment includes a storage tank 50 into which is poured, on the one hand, the contaminated water to be treated from toilets and the like and, on the other hand, the concentrated residue coming from the distiller 1.

The tank 50 is divided into two compartments 51 and 52 by a mesh dividing wall 53; into compartment 51 are poured the concentrated residues and the water to be treated, and from compartment 52 the water to be treated is sucked towards the heat recuperator 40 (or, in an embodiment without recuperator, directly towards the distiller 1).

In this case, as FIG. 4 shows, the heat recuperator 40 can also be used to fulfil a decantation function, for which purpose the water to be treated is fed to the recuperator above the bottom of the latter, through a tube 54, and the bottom of the recuperator is fitted with an outlet tube 55 to take the residue to compartment 51 of the tank 50.

The difference when compared with the preceding embodiments is that here a tank of high capacity (say, 200 litres) is provided, in which the concentration of the solid carries on increasing and so the solid must be emptied at intervals; treatment in accordance with the invention nevertheless permits the emptying interval to be very much longer than with other systems. Equipment of this type could require, for example, emptying every 6 months.

Another, very complete, embodiment of sewage treatment equipment in accordance with the invention is shown in FIG. 5.

The equipment of FIG. 5 includes a distiller 1, a heat recuperator 40, a separator tank 60 and a drying unit 70.

The separator tank 60 here has two chambers 61 and 62, on which is mounted a conveyor screw 63.

Through an inlet mouth 64, the conveyor 63 receives the sewage to be treated. The bottom 65 of the conveyor which is on the chamber 61 is perforated or with a mesh, in order to let most of the water pass. Most of the solid, on the other hand, is drawn along by the conveyor screw and passed through an outlet mouth 66 to the chamber 62.

The separator tank also acts as a regulator, to which end it is provided with maximum and minimum level sensors (not shown) so that the process can be halted or started up a suitable intervals. This separator tank does not require emptying, as will be seen below, and can have a capacity of up to 25 litres.

The more liquid fraction of the waters to be treated is sucked by a pump from the chamber 61 of the separator tank 60 towards the heat recuperator 40, where it is preheated and then passes on to the distiller 1, as already described. As in the other cases, the distilled water is collected, after it has given up its residual heat in the recuperator 40, in a clean-water tank 4.

In relation to the concentrated residue, provision has been made here for each of the parts (both chambers of the separator tank, the heat recuperator and the distiller) to have outlets for the concentrated residues or solids which they decant; all these outlets, each with its corresponding control valve, emerge into a tube 67 which leads to the drying unit 70.

This unit 70 is made up of a heated compartment 71, in which, by means of an annular heating element 72, the concentrated residues are heated following a predetermined process until they have been totally inertised and dried. A temperature sensor 73 allows the process to be controlled.

An evacuation duct 74 permits the dry solids to be expelled to the exterior, for example by dropping them onto the track in the case of a railway, or stored for subsequent withdrawal. In this respect, it should be borne in mind that the volume of residues once dried is extremely small, and that the drying process turns them into an inert, odourless and non-contaminating powder.

Through an appropriate duct 75 air can be injected into the compartment 71, both in order to facilitate the chemical reactions and to extract the dry residues by blowing at the end of the process.

At various points of the equipment exhaust ducts 80, 81, 82 are provided for the gases generated during the treatment, with all these ducts leading to a single absorbent filter 83, for example of activated charcoal, before the gases are released into the atmosphere. Additionally, the gases can be treated with oxidants, such as ozone, fed in through the duct 84.

Since the residual waters will contain a certain amount of ammonia, a catalyst (not shown) of the type that eliminates ammonia by oxidation or cracking can be fitted. This catalyst can be fitted, together with the filter 83, at the smoke outlet for the equipment as a whole or, for example, at the outlet from the steam compressor 23 to the distiller 1.

In the embodiment of FIG. 5 various treatment units have been combined; many variants can clearly be provided, such as equipment with a separator tank constructed like tank 50 in FIG. 4, without the conveyor screw 63, or the drying unit could be applied to the equipment of FIGS. 1 or 3; similarly, the heat recuperator 40 is an optional element which could be omitted in any of the equipment layouts described, while the exhaust gases ducting and treatment could be applied to any of the layouts of the equipment.

Despite the fact that one specific embodiment of this invention has been described and shown, it will be obvious that an expert in the subject could introduce variants and modifications, or replace the details by others that are technically equivalent, without departing from the sphere of protection defined in the attached claims.

For example, although only one exchanger with smooth, round tubes has been described, tubes or ducts of any section can clearly be used, whether smooth, corrugated or the like, and any type of cooling fins can be provided. In the same way, all the conventional variants of heat exchangers can be incorporated into the distiller or heat recuperator, according to the characteristics of each specific case.

All kinds of process-control devices could also be fitted, such as temperature, pressure and level sensors, etc., to ensure the good operation of the distiller and the equipment as a whole.

Some of the possible sensors have been shown in schematic form in the figures, though without reference numbers; similarly, the drawings include some flow and control valves whose description was deemed unnecessary for experts in the subject, who would easily understand their usefulness and operation.

In particular, the valves will permit flow-control for each of the fluids involved in the process, in accordance with readings from suitable temperature and level sensors, etc., so that the equipment operates in an automated manner.

1. Distiller (1) for liquids, which includes a heat exchanger (6) with a housing which contains a plurality of tubes (7), into which is fed the liquid to be treated, means (9, 10) of supplying the liquid to the tubes, means (14) of heating the liquid, means (23) for compressing the steam from evaporation of the liquid, means (24) for feeding the compressed steam into the housing around the tubes (7) and means (26, 12) for removing on the one hand the condensate and on the other the concentrated residue, wherein the liquid-feed means (9, 10) keep the tubes (7) full of liquid up to an intermediate predetermined level, in that said distiller (1) further includes means (27, 28) for inducing turbulence in the liquid which is in the tubes (7) and in that it comprises a level device (29) with level sensors (30).

2. Distiller as claimed in claim 1, wherein the means for inducing turbulence in the liquid include a duct (28) for injecting some of the steam coming from the compressor into the liquid.

3. Distiller as claimed in claim 2, wherein said duct (28) for injecting some of the steam into the liquid runs in the bottom part of the distiller (1) and consists in a tube (28) with a plurality of lateral steam outlet orifices.

4. Distiller as claimed in claim 1, wherein it also includes a substantially horizontal plate (15) situated inside the housing, above the tubes (7), with a diameter less than that of the housing.

5. Distiller as claimed in claim 1, wherein it also includes a filter (17) of perforated plates (18, 19), situated above the tubes (7).

6. Distiller as claimed in claim 5, wherein said filter (17) is made up of a horizontal plate (19) with a perforated central zone (20) and at least one perforated annular plate (18), fixed onto the bottom part of said horizontal plate (19), around its perforated central zone (20).

7. Distiller as claimed in claim 1, wherein the housing has a lower tank (8), connected to the tubes (7) and surrounded by the means (14) of heating the liquid.

8. Distiller as claimed in claim 7, wherein said lower tank (8) has a duct (12) with a valve (13) for extracting the concentrated residues.

9. Distiller as claimed in claim 1, wherein said means (23) for compressing the steam consist in a side-channel blower.

10. Distiller as claimed in claim 1, wherein it includes a condensate outlet (26) calibrated to a predetermined diameter.

11. Distiller as claimed in claim 1, wherein its housing is made of up an intermediate section (6) with the tubes (7) of the heat exchanger, an upper section (5) with a steam outlet (21) and a lower section (8) with an inlet (9) for the liquid to be treated and with a concentrated residue outlet (12), these three sections (5, 6, 8) being attached to each other by means of detachable fixing means.

12. Liquids distillation method which includes the following operations:
heating the liquid to be treated and delivering it inside the tubes (7) of a heat exchanger (6);
compressing the steam resulting from evaporation of the liquid and bringing it into contact with the exterior wall of the exchanger (6) tubes (7); and
removing the condensate and the concentrated residue;
wherein
the liquid inside the tubes (7) of the exchanger (6) is maintained up to certain level; and
turbulence is induced in the liquid in the tubes (7).

13. Method as claimed in claim 12, wherein said turbulence in the liquid is induced by injecting some of the compressed steam into the liquid to make it bubble.

14. Method as claimed in claim 11, wherein it includes a stage of preheating the liquid to be treated, with recuperation of the heat of the condensate obtained from the steam.

15. Equipment for treating sewage, wherein it includes a distiller (1) as claimed in claim 1.

16. Equipment as claimed in claim 15, wherein it further includes a heat recuperator (40) for preheating the water to be treated, in which the condensate extracted from the distiller (1) gives up heat to the water to be treated, before the water is supplied to the distiller (1).

17. Equipment as claimed in claim 15, wherein it includes a residues storage tank (50) divided into two parts (51, 52) by a filtering divider (53), with one (51) of the parts of the tank connected to an inlet duct for the sewage to be treated and an inlet duct (12) for the concentrate residue from the distiller (1), while the other part (52) of the tank is connected to a suction duct (54) for water to be treated.

18. Equipment as claimed in claim 15, wherein it also includes means for drying (70) the concentrated residues.

19. Equipment as claimed in claim 18, wherein said means of drying (70) include a compartment (71) with means of heating (72) and provided with an inlet (67) for the concentrated residues, an outlet (74) for the dry residues, a gases and smoke outlet (82) and a duct (75) for feeding in air.

20. Equipment as claimed in claims 15, wherein it also includes means (63) of mechanical separation of the solids contained in suspension in the sewage before they are fed to the distiller.

21. Equipment as claimed in claim 20, wherein said means of mechanical separation of the solids include a screw conveyor (63) whose housing has a perforated lower part (65) for the outlet of liquid through it.

22. Equipment as claimed in claim 15, wherein it includes a catalyst for elimination of ammonia, situated at the outlet from the steam compression means (23) or in a smoke outlet duct.
